(19) United States
(12) Patent Application Publication
(10) Pub. No.: US 2024/0395125 A1
(43) Pub. Date: Nov. 28, 2024

(54) Bandwidth and power-optimized hybrid high-resolution/low-resolution sensor method for a predictive analytics system

(71) Applicant: Wesley Cheng, Haymarket, VA (US)

(72) Inventor: Wesley Cheng, Haymarket, VA (US)

(21) Appl. No.: 18/201,648

(22) Filed: May 24, 2023

(51) Int. Cl. G08B 21/04

(52) U.S. Cl. CPC G08B 21/043; G08B 21/0492

(57) ABSTRACT

A hybrid system includes utilizing high-resolution and low-resolution sensors that complement each other. The low-resolution sensors connect to the edge computer using a network interface typical for such sub-systems, such as zigbee or z-wave mesh networks. The data is forwarded to the cloud server for analysis. Should there be an atypical event detected, the edge computer can then be triggered to send control signals to the various high-resolution sensors to send/receive data. The high-resolution sensors therefore only need to be used for a very small fraction of the time. The high-resolution system can include an edge computer on premise to pre-process the signals from the high-resolution sensors into specific information that can be sent to the cloud server. This greatly reduces the bandwidth requirements.

This application is related to copending application Ser. No. ______, ______, ______, ______ entitled “People Wellness Monitoring” and to copending application Ser. No. ______, entitled “Autonomous Circadian Lighting System with Environmental and Sensor Input”, the content of which is incorporated by reference.

### BACKGROUND OF THE INVENTION

This invention relates to the field of predictive analytics systems and, more particularly, to a bandwidth and power-optimized hybrid high-resolution/low-resolution sensor method for predictive analytics systems.

Predictive analytics systems enable organizations to identify trends and predict future outcomes by analyzing data from multiple sources. Predictive analytics is used to uncover hidden relationships between variables, identify potential risks and opportunities, and better understand customer behavior. Predictive analytics requires accurate data to be collected from sensors capable of capturing high-resolution and low-resolution data. However, high-resolution sensors are often expensive and require significant bandwidth and power. Low-resolution sensors are often cheaper but may not provide enough data for accurate predictions.

Therefore, there is a need for an improved method for collecting data from sensors in a predictive analytics system. This invention provides a bandwidth and power-optimized hybrid high-resolution/low-resolution sensor method for predictive analytics system. The proposed method combines the benefits of high-resolution and low-resolution sensors, allowing predictive analytics systems to collect data accurately while reducing cost, bandwidth and power requirements.

### SUMMARY OF THE INVENTION

A hybrid system includes utilizing high-resolution and low-resolution sensors that complement each other. The low-resolution sensors connect to the edge computer using a network interface typical for such sub-systems, such as ZigBee or Z-wave mesh networks. The data is forwarded to the cloud server for analysis. Should an atypical event be detected, the edge computer can then be triggered to send control signals to the various high-resolution sensors to send/receive data. Therefore, the high-resolution sensors only need to be used for a small fraction of the time. The high-resolution system can include an edge computer on-premise to pre-process the signals from the high-resolution sensors into specific information that can be sent to the cloud server. The hybrid system uses low power and does not need to be plugged into AC power.

In another aspect, an analytical process includes a hybrid system for collecting data and sending control signals with a combination of high-resolution sensors and low-resolution sensors connected to an edge computer. The edge computer pre-processes the data from the low-resolution sensors into specific information that can be sent to a cloud server. The cloud server then performs analytics on the data and can trigger the edge computer to send control signals to the various high-resolution sensors. The high-resolution sensors are powered on and not required to be plugged into wall power because they are utilized infrequently and can be battery powered. This dramatically reduces the bandwidth requirements while still ensuring the accuracy of the data collected.

Advantages of the invention may include one or more of the following:
Reduced cost of operation due to the use of low-resolution sensors for most operations;
Low power consumption since the high-resolution sensors only need to be activated when necessary;
Increased accuracy due to the combination of high-resolution and low-resolution data; and
Reduced bandwidth requirements due to pre-processing of the data on the edge computer.

The hybrid system described above combines the benefits of high-resolution and low-resolution sensors, allowing predictive analytics systems to collect data accurately while reducing cost, bandwidth and power requirements. In addition, the hybrid system provides increased accuracy due to the combination of high-resolution and low-resolution data.

### BRIEF DESCRIPTION OF DRAWINGS

Turning now descriptively to the drawings, in which similar reference characters denote similar elements throughout the several views, the figures illustrate the electronic book of the present invention. With regard to the reference numerals used, the following numbering is used throughout the various drawing figures.

FIG. 1 shows an exemplary diagram of a low-resolution sub-system.

FIG. 2 shows an exemplary diagram of a high-resolution sub-system with high-resolution sensors.

FIG. 3 shows an exemplary diagram of an edge signal processor with a rules engine.

FIG. 4 shows an exemplary diagram of a hybrid system to handle low and high-resolution sensors.

### DETAILED DESCRIPTION OF THE INVENTION

The following discussion describes in detail one embodiment of the invention (and several variations of that embodiment). This discussion should not be construed, however, as limiting the invention to those particular embodiments, practitioners skilled in the art will recognize numerous other embodiments as well. For a definition of the complete scope of the invention, the reader is directed to appended claims.

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

This invention now will be described more fully hereinafter with reference to the accompanying drawings, in which exemplary embodiments are shown. Various embodiments are now described with reference to the drawings, wherein such as reference numerals are used to refer to such as elements throughout. In the following description, for purposes of explanation, numerous specific details are set forth in order to provide a thorough understanding of one or more embodiments. It may be evident, however, that such embodiment(s) may be practiced without these specific details. In other instances, well-known structures and devices are shown in block diagram form in order to facilitate describing one or more embodiments.

This invention may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and such as represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named manufacturer.

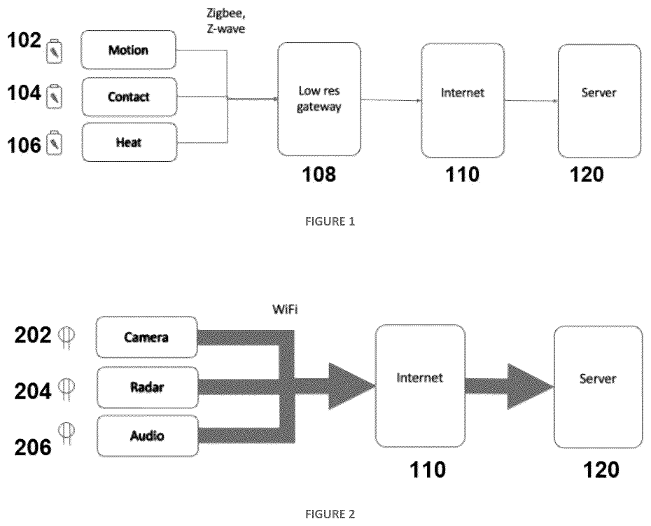

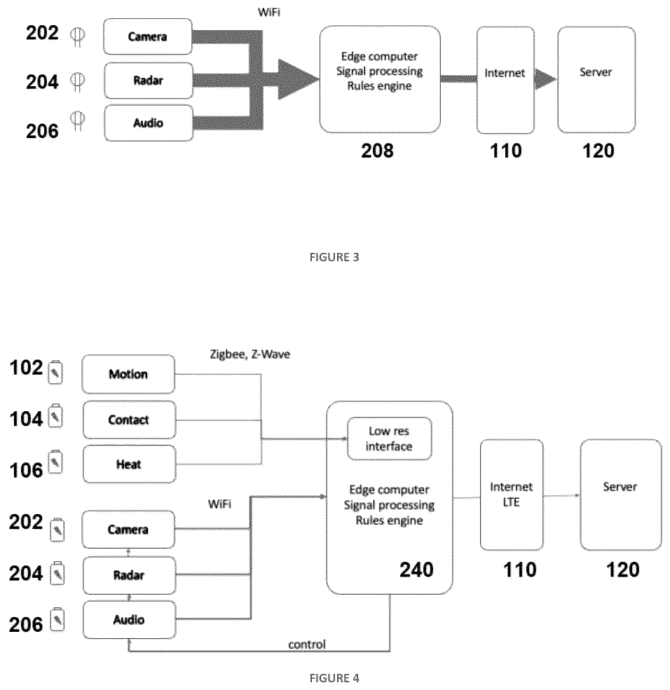

FIG. 1 shows an exemplary diagram of a low-resolution sub-system, and FIG. 2 shows an exemplary diagram of a high-resolution sub-system with high-resolution sensors. FIG. 3 shows an exemplary diagram of an edge signal processor with a rules engine, while FIG. 4 shows an exemplary diagram of a hybrid system to handle low- and high-resolution sensors.

Turning now to FIG. 1, an exemplary diagram of a low-resolution sub-system is shown. The low-resolution system of FIG. 1 uses sensors that provide low-resolution data, such as passive infrared (PIR) sensors for motion detection, contact sensors for door/window opening/closing, and heat sensors. The sensors use very little power and are often battery-operated. They can thus be located anywhere. These systems use little bandwidth. However, they often lack the detail to confirm that an event has occurred, such as a resident who has fallen.

Motion sensor 102 is a low-resolution sensor that detects motion and sends a signal to the low-res gateway 108. The gateway 108 then processes the signal and forwards it over the internet 110 to a cloud server 120. Should the motion sensor 102 detect an atypical event, such as an intruder entering the premises, server 120 can trigger the high-resolution cameras of FIG. 2. The cameras will then capture images of the scene and send them to the edge computer for processing. The edge computer then sends the processed data to the cloud server for further analysis. The system can also trigger other high-resolution sensors such as thermal sensors, acoustic sensors, and other sensors that can provide additional data to aid in the analysis.

Contact sensor 104 is a low-resolution sensor as it only reports whether a contact has been made. Other low-res sensors include pressure sensor or temperature sensor used to measure changes in pressure or temperature over time. The contact sensor is connected to a gateway 108 via a network interface, such as zigbee or z-wave mesh networks. The data from contact sensor is then forwarded to a cloud server 120 over the Internet 110 for analysis.

Heat sensor 106 may be a thermocouple or other type of temperature sensor that is capable of capturing temperature low-resolution data. The gateway 108 is configured to pre-process the data from heat sensor 106 and send it to cloud server 120. The gateway 108 may also be connected to one or more low-resolution sensors via network interface. Low-resolution sensors may be any type of sensor such as accelerometers, gyroscopes, pressure sensors, and temperature sensors. Other low-resolution sensors include an accelerometer, a temperature sensor, a light sensor, a proximity sensor, a humidity sensor, a pressure sensor, a vibration sensor, or other type of sensor that may detect sound, light, temperature, pressure, acceleration, or other environmental parameters.

Low-resolution sensor gateway 108 includes a gateway controller that is connected to one or more low-resolution sensors. The gateway controller can receive data from the low-resolution sensors and transmit the data to the cloud server. The gateway controller can also receive control signals from the cloud server 120, which can be used to activate and deactivate the low-resolution sensors. The data collected by low-resolution sensors is transmitted to the edge computer via the network interface. A processor is configured to pre-process the data from low-resolution sensors and send it to the cloud server.

FIG. 2 shows an exemplary diagram of a high-resolution sub-system with high-resolution sensors which capture media-rich information, such as audiovisual information, and can consume significant bandwidth and power. Examples include cameras, RADAR, and microphones. These systems send voluminous data across the Internet 110 to cloud-based servers 120, which analyze the data. Because of the power requirements, the sensors need to be plugged into wall power and cannot be battery-powered. This restricts where they can be located. Often, areas that require monitoring do not have power available which limits the applications. High-resolution systems also require high bandwidth Internet connectivity. Certain environments do not have such connectivity, where the only option is a wireless option, such as cellular or satellite data.

A video camera 202 and microphone 206 are examples of high-resolution sensors that may be used to collect data in a predictive analytics system. In one embodiment, the video camera is connected to a network interface typical for such sub-systems, such as an Ethernet connection or a Wi-Fi connection to send data to the cloud server 120.

Radar 204 is a high-resolution sensor and can be used to detect changes in the environment with great accuracy. A radar processor can pre-process the data from the radar into specific information that can be sent to the cloud server 120. This pre-processing step significantly reduces the bandwidth requirements while the radar is still powered on/and plugged into wall power.

Microphone or audio device 206 may be connected to server 120 via a wired or wireless connection. The edge computer may include one or more processors, memory, and a network interface. The edge computer may be used to process the data received from the low-resolution sensors and the high-resolution sensor. The edge computer may analyze the data received from the low-resolution sensors to detect anomalies or events. If an anomaly or event is detected, the edge computer may trigger the high-resolution sensor to send data to the cloud server for further analysis. The cloud server may include one or more processors, memory, and a network interface. The cloud server may receive data from the high-resolution sensor and analyze it using predictive analytics algorithms to make predictions or detect trends. The results of the analysis may then be sent back to the edge computer for further processing or actuation.

Internet 110 connects edge computers and cloud server, as well as high-resolution sensors and low-resolution sensors. High-resolution sensors are connected to server 120 via a network interface typical for such sub-systems, such as Wi-Fi or wired Ethernet ports. Edge computer receives data from high-resolution sensors, which is then sent to cloud server 120 for analysis.

A variation of the high-resolution system is to insert an edge computer 208 to pre-process the signals from the high-resolution sensors into specific information that can be sent to the cloud server 120. This greatly reduces the bandwidth requirements. In order to pre-process the signals from the high-resolution sensors, the edge computer may be installed on premise (FIG. 3), which reduces the bandwidth requirements while the sensors are still powered on/and plugged into wall power. The edge computer includes a processing module, memory, and a network interface, allowing it to connect to both low-resolution sensors and high-resolution sensors. The edge computer collects data from high-resolution sensors via the network interface, such as a zigbee or z-wave mesh network, and sends it to the cloud server for analysis. The edge computer also receives control signals from the cloud server, which can be used to activate the high-resolution sensors when needed.

FIG. 4 shows an exemplary diagram of a hybrid system with a low-resolution interface coupled to an edge signal computer 240 having a rules engine. The high-resolution sub-system includes an edge computer connected to one or more high-resolution sensors. The edge computer can receive data from the high-resolution sensors and pre-process the data into specific information that can be transmitted to the cloud server. The edge computer can also receive control signals from the cloud server, which can be used to activate and deactivate the high-resolution sensors. The hybrid system is designed to optimize the power consumption and bandwidth requirements of the predictive analytics system. The low-resolution sensors are connected to the low-resolution interface and can be left on since they consume relatively little power. The high-resolution sensors are connected to the edge computer and can be activated only when necessary, thereby reducing power consumption and bandwidth requirements. When the cloud server detects an atypical event, it can send control signals to the low-resolution gateway and edge computing, which can then be used to activate and deactivate the low-resolution and high-resolution sensors, respectively. For example, if a motion detector detects an unexpected motion, an edge computer can then be triggered to send control signals to the video camera and contact sensor to send/receive data. This allows the high-resolution sensors to be used only when necessary, thus reducing the power and bandwidth requirements.

Radar 208, microphone or audio device 206, and cameras 202 are all examples of high-resolution sensors. High-resolution sensors typically have a large dynamic range, meaning they can measure a wide range of values from low to high. Examples of low-resolution sensors include temperature sensors, humidity sensors, and air quality sensors. Low-resolution sensors such as contact sensors and temperature sensors typically have a small dynamic range, meaning they can only measure a limited range of values. The hybrid system of this invention utilizes both high-resolution and low-resolution sensors and the edge computer on-premise to pre-process the signals from the high-resolution sensors into specific information that can be sent to the cloud server. This greatly reduces the bandwidth requirements while the sensors are still powered on/and plugged into wall power. The edge computer can also perform additional processing of the data before sending it to the cloud server, such as anomaly detection or other machine learning algorithms.

Server 120 may include a cloud server, edge computer, or other computing device that is configured to receive data from one or more high-resolution sensors and one or more low-resolution sensors. The high-resolution sensors are configured to detect events or conditions that may require further investigation, such as abnormal temperatures or motion in a given area. The low-resolution sensors are configured to detect events or conditions that do not require further investigation, such as light or sound levels. The server is configured to receive data from the high-resolution and low-resolution sensors via a network interface (not shown). The network interface may be a wired or wireless connection, such as a Zigbee or Z-wave mesh network. The data is forwarded to the server for analysis. When the server detects an atypical event or condition, it is configured to send control signals to the high-resolution sensors to send/receive data. The high-resolution sensors then provide more detailed data to the server. This allows the predictive analytics system to collect more accurate data while minimizing power and bandwidth consumption. The server may also include an edge computer on premise to pre-process the signals from the high-resolution sensors into specific information that can be sent to the cloud server. This further reduces the bandwidth requirements while the sensors are still powered on/and plugged into wall power. Edge computer signal processing rule engine may be further configured to receive the data from the high-resolution sensors, pre-process the data, and then forward the pre-processed data to cloud server. This pre-processing may include normalization of the data, smoothing of the data, and/or aggregation of the data. In this manner, the data collected by the high-resolution sensors may be processed in real-time, thereby reducing the bandwidth requirements for transmitting the data from the high-resolution sensors to cloud server.

In one example, camera 202 includes an image sensor and a lens system, and may be used to capture images of objects in the environment. The image data collected by camera can be pre-processed by edge computer before being sent to cloud server for further analysis. Edge computer can also receive data from low-resolution sensors, such as temperature sensor, motion sensor, and sound sensor. The data collected by these low-resolution sensors can be used to determine the current state of the environment and trigger camera to collect additional data if needed. The data collected by camera can then be sent to cloud server for further analysis.

The hybrid system has several advantages over traditional predictive analytics systems. By utilizing a combination of high-resolution and low-resolution sensors, the proposed method can reduce cost and power consumption while still providing accurate data for predictive analytics. Additionally, the pre-processing of data by edge computer can reduce bandwidth requirements, allowing for more efficient transmission of data to cloud server. This is illustrated in the next few examples.

### Example 1—Fall Detection

When an event is triggered, eg. a fall, only then is the relevant high-resolution data sent to the backend to be validated by data science algorithms in the cloud. For example, a control signal sent by the edge computer may trigger the following:
Camera may send a still photo or short video clip, or
Radar sensor may send an image, or the microphone may start listening and send a short audio clip

This dramatically reduces the amount of power required by the high-resolution sensors. In typical high-resolution systems, the sensors are not recording anything useful most of the time, which wastes power and bandwidth.

The system with example 1 is designed to detect and respond to potentially dangerous situations in a residential or care home environment. The system uses a network of cameras and image recognition Al to identify if a resident is in any of the monitored zones. When no motion is detected in any of the zones for a long time, the system sends a control signal to all the cameras to capture one still image for each location. The captured images are then processed by the image recognition Al to determine if a resident is in any of the zones. If a resident is found in a prone position, it is assumed that they have had a fall, and the system sends a message to a cloud server to create an alert. This alert can be sent to caregivers, family members, or emergency services, depending on the configuration of the system. If a resident is not detected in any of the monitored zones, the system assumes that they are missing and sends a message to the cloud server to create an alert. This alert can be used to quickly locate the resident and ensure their safety. In this manner, the system provides a reliable and automated way to monitor the well-being of residents in a care home or similar environment and can help to quickly detect and respond to potentially dangerous situations.

### Example 2—Resident Assistance

The following pseudo-code may be used for sending an image from a camera when an atypical event is detected by low-resolution sensors:

| 1 | if (no motion seen in any zone for a long time) | // resident may need help |
|---|---|---|
| 2 | send control signals to all cameras to send one still image for each location | |
| 3 | use image recognition AI to determine if the resident is in any of the zones | |
| 4 | if (resident is found in prone position) | // resident had a fall |
| 5 | send a message to the cloud server to create an alert | |
| 6 | if (resident is not detected in any zone) | // resident is missing |

| | |
|---|---|
| 7 | send message to cloud server to create alert |

### Example 3—Bathroom Check-In

The following pseudo code may be used to open a 2-way audio connection when the system detects an atypical event, such as a long time in the bathroom

| | |
|---|---|
| 1 | if (bathroom occupied > threshold) // resident has spent too |
| | much time in bathroom |
| 2 | wait for operator to be available |
| 3 | send control signal in bathroom to turn on mic and speaker |
| 4 | operator initiates conversation to ask if resident is OK |
| 5 | if (no response from resident \| \| resident says help is needed) |
| 6 | operator can inform emergency services |
| 7 | operator waits until emergency services arrives |
| 8 | send control signal in bathroom to turn off mic and speaker |

### Example 4—Fall Detection with Radar

The following pseudo code may be used to confirm a fall

| 1 | if (occupancy in bathroom > threshold) | // resident may be stuck in bathroom |
|---|---|---|
| 2 | send control signal to radar in bathroom to turn on | |
| 3 | analyze radar signal to determine position of resident | |
| 4 | if position of resident is horizontal | // probably a fall |

| | |
|---|---|
| 5 | send message to cloud server to create alert |
| 6 | send control signal to radar in bathroom to turn off |

### Example 5—Getting Out of Bed

The following pseudo code may be used to proactively detect falls. This is especially critical when the resident is getting out of bed because they are most vulnerable at that time.

| | |
|---|---|
| 1 | if (motion detected in bedroom && resident is in bed) // |
| | resident may be getting up |
| 2 | send control signal to turn on radar |
| 3 | for the next 5 minutes // window of vulnerability when resident |
| | is getting up |
| 4 | analyze radar for possible acceleration indicating possible falls |
| 5 | if fall detected, send message to cloud server to create alert |
| 6 | check for continued motion for next 10 minutes // stay on alert |
| 7 | if no further motion |
| 8 | send control signal to turn off radar |

The process further includes the present invention utilizes a hybrid system comprising a plurality of low-resolution sensors connected to an edge computer via a network interface such as Zigbee or Z-Wave mesh networks. The data collected by the low-resolution sensors is forwarded to the cloud server for analysis. Should an atypical event be detected, the edge computer can then be triggered to send control signals to the various high-resolution sensors to send/receive data. This method allows the high-resolution sensors to only be used for a very small fraction of the time, thus reducing the cost and power consumption of operation. Additionally, the edge computer is able to pre-process the signals from the high-resolution sensors into specific information that can be sent to the cloud server. This greatly reduces the bandwidth requirements while the sensors are still powered on/and plugged into wall power.

The process further includes the proposed system comprises a plurality of high-resolution sensors connected to the edge computer. The high-resolution sensors are capable of providing detailed data about the environment. Examples of such sensors may include cameras, LiDAR, pressure sensors, etc. The edge computer receives data from the high-resolution sensors and processes it into meaningful information that can be sent to the cloud server. The edge computer is connected to a network interface typical for such sub-systems, such as ZigBee or z-wave mesh networks. The data is then forwarded to the cloud server for further analysis.

The process further includes the cloud server having one or more processors for receiving data from the low-resolution sensors, analyzing the data, and determining if an atypical event has occurred. The cloud server also includes memory for storing data received from low-resolution sensors and software applications for analyzing the data. In some embodiments, the cloud server may be further configured to transmit control signals to the high-resolution sensors, instructing them to send data when an atypical event is detected.

The process further includes the edge computer configured to detect atypical events using the low-resolution sensors. Upon detection of an atypical event, the edge computer is triggered to send control signals to the various high-resolution sensors. The control signals can be used to activate the high-resolution sensors, instruct them to collect data, and send the data to the cloud server for further analysis. The high-resolution sensors are only activated when necessary, thus reducing power consumption and bandwidth requirements.

The high-resolution sensors can be battery powered or plugged into wall power, providing an always-on data source. The data is pre-processed on an edge computer, which is connected to the high-resolution sensors, before being sent to the cloud server for further analysis. This reduces the bandwidth requirements, as only the pre-processed data is sent over the network, allowing the predictive analytics system to take advantage of the always-on data source without the need for significant bandwidth.

The process further includes the edge computer is configured to receive signals from the high-resolution sensors and pre-process the signals into specific information that can be sent to the cloud server. The pre-processing step reduces the bandwidth requirements by reducing the amount of data that needs to be transmitted, while the sensors remain powered on/and plugged into wall power. The edge computer is also configured to send control signals to the various high-resolution sensors when an atypical event is detected, so that the sensors only need to be used for a very small fraction of the time.

Various modifications and alterations of the invention will become apparent to those skilled in the art without departing from the spirit and scope of the invention, which is defined by the accompanying claims. It should be noted that steps recited in any method claims below do not necessarily need to be performed in the order that they are recited. Those of ordinary skill in the art will recognize variations in performing the steps from the order in which they are recited. In addition, the lack of mention or discussion of a feature, step, or component provides the basis for claims where the absent feature or component is excluded by way of a proviso or similar claim language.

While various embodiments of the present invention have been described above, it should be understood that they have been presented by way of example only and not of limitation. The various diagrams may depict an example architectural or other configuration for the invention, which is done to aid in understanding the features and functionality that may be included in the invention. The invention is not restricted to the illustrated example architectures or configurations, but the desired features may be implemented using a variety of alternative architectures and configurations. Indeed, it will be apparent to one of skill in the art how alternative functional, logical, or physical partitioning and configurations may be implemented to implement the desired features of the present invention. Also, a multitude of different constituent module names other than those depicted herein may be applied to the various partitions. Additionally, with regard to flow diagrams, operational descriptions, and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects, and functionality described in one or more of the individual embodiments are not limited in their applicability to the particular embodiment with which they are described, but instead may be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open-ended as opposed to limiting. As examples of the foregoing: the term “including” should be read as meaning “including, without limitation” or the such as; the term “example” is used to provide exemplary instances of the item in discussion, not an exhaustive or limiting list thereof; the terms “a” or “an” should be read as meaning “at least one,” “one or more” or the such as; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Hence, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other such as phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and may further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

It is to be understood that the above description is intended to be illustrative, and not restrictive. For example, the above-described embodiments (and/or aspects thereof) may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects. The Abstract of the Disclosure is provided to comply with 37 CFR &sect; 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, various features may be grouped together to streamline the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separate embodiment.

1. A method to determine if one or more subjects need assistance, comprising:
collecting first data from one or more first sensors each with a first predetermined data output rate;
collecting second data from one or more second sensors, each with a second predetermined data output rate, wherein the second predetermined output rate is greater than the first predetermined data output rate;
pre-processing the second data at an edge computer before sending the first and second data to a server; and
based on outputs from the one or more first sensors, controlling the one or more second sensors to capture additional inputs to determine if assistance is needed by the one or more subjects.

2. The method of claim 1, wherein the one or more first sensors include a motion sensor, a contact sensor, or a heat sensor.

3. The method of claim 1, wherein the one or more second sensors include a camera, a RADAR, a LIDAR, a microphone, or an audio sensor.

4. The method of claim 1, comprising wirelessly collecting data from the one or more first sensors using a personal area network.

5. The method of claim 1, comprising wirelessly collecting data from the one or more second sensors using a wireless local area network (WLAN) or a cellular network.

6. The method of claim 1, comprising detecting a fall using the edge computer and sending first and second data to the cloud server to get assistance.

7. The method of claim 1, comprising detecting if one of the subject is in a bathroom for more than a safe period and communicating with the subject regarding assistance.

8. The method of claim 1, comprising confirming a fall with a radar sensor.

9. The method of claim 1, comprising monitoring for a fall from getting out of bed by detecting motion when the subject is on a bed and analyzing a radar output to detect the fall.

10. The method of claim 1, comprising detecting an absence of motion for a predetermined period and then turning on all cameras and applying image recognition to detect the subject and creating an alert if the subject is not detected or if the subject is in a prone position indicative of a fall.

11. A system to perform assistance check for one or more subjects, comprising:
an edge computer;
a plurality of low-resolution sensors connected to the edge computer, wherein the low-resolution sensors generate data at a first data rate;
a plurality of high-resolution sensors connected to the edge computer, wherein the high-resolution sensors generate data at second data rate greater than the first data rate; and
a cloud server coupled to the edge computer to process the data from the edge computer, wherein the edge computer is configured to pre-process signals from the high-resolution sensors into specific information before sending it to the cloud server, and wherein the edge computer is configured to send control signals to the high-resolution sensors in response to an atypical event detected by the low-resolution sensors.

12. The system of claim 11, wherein the edge computer is configured to send control signals to the sensors to trigger specific actions when predetermined conditions are met.

13. The system of claim 1, wherein the control signal triggers the camera to capture one still photo or a short video clip of the monitored area.

14. The system of claim 11, wherein the control signal triggers the radar sensor to send an image of the monitored area.

15. The system of claim 11, wherein the control signal triggers the microphone to start listening and send a short audio clip of the monitored area.

16. The system of claim 11, wherein the control signal is triggered when the edge computer detects a lack of motion in the monitored area for a predetermined amount of time.

17. The system of claim 11, wherein the control signal is triggered when the edge computer detects abnormal activity or behavior in the monitored area.

18. The system of claim 11, further comprising an analysis module that analyzes the data received from the sensors and sends alerts to the cloud server when potential dangers are detected.

19. The system of claim 11, wherein the cloud server is configured to receive alerts from the analysis module and send notifications to caregivers, family members, or emergency services.

20. The system of claim 11, further comprising a data storage module that stores historical data on the movements and behaviors of individuals in the monitored area, allowing for more accurate and effective analysis of potential dangers.
